(19) United States
(12) Patent Application Publication
(10) Pub. No.: US 2018/0345745 A1
(43) Pub. Date: Dec. 6, 2018

(54) Collapsible Adjustable Height Stabilizer

(71) Applicant: David Allen Bowar, Casper, WY (US)

(72) Inventor: David Allen Bowar, Casper, WY (US)

(21) Appl. No.: 15/610,698

(22) Filed: Jun. 1, 2017

(51) Int. Cl. B60D 1/66; B60S 9/04; F16M 11/26

(52) U.S. Cl. CPC B60D 1/66; F16M 11/26; B60S 9/04

(57) ABSTRACT

A collapsible mechanism for stabilizing a stationary free standing towed wheeled vehicle containing a towing coupler such as a king pin, or towing ball is disclosed. The mechanism comprises of a mounting plate that affixes to the towing coupler of a stationary free standing towed wheeled vehicle. A pair of pivoting collapsible adjustable height support legs attaches to the mounting plate and extend to the ground. A tensioning device is attached between the support legs. As the tensioning device is tightened, the support legs are drawn towards each other, creating a rigid body. The rigid body reacts with the towing coupler, adding rigidity to the towed wheeled vehicle, eliminating unwanted motion of the stationary free standing towed wheeled vehicle.

### CROSS-REFERENCE TO RELATED APPLICATIONS

This application claims priority from a previously filed provisional patent application Ser. No. 62/347,146, filed Jun. 8, 2016, entitled “Collapsible Adjustable Height Stabilizer” by the same inventor.

### BACKGROUND OF THE INVENTION

### Field of the Invention

The present invention relates to a stationary free standing towed wheeled vehicle. The focus of the present invention is the stabilization of a stationary free standing towed wheeled vehicle to eliminate unwanted motion of the stationary free standing towed wheeled vehicle. A towed wheeled vehicle may include, but is not limited to fifth wheel recreational vehicle trailers, travel trailer recreational vehicle, and livestock trailers

### Description of the Prior Art

A towed wheeled vehicle is designed by the manufacture to have a suspension system suitable for highway use. This type of suspension system is usually somewhat soft and forgiving while ideal for use on the highway, the soft suspension allows for unwanted motion of a stationary free standing towed wheeled vehicle.

Stabilization of towed wheeled vehicles has been a common problem and various apparatus exist. Many variations exist, some devices use permanent mounts on or around the towing coupler, and some devices are attached only when the tow vehicle has been removed. Many existing stabilizers use two or three support legs, sometimes along with a tensioning device to create a support apparatus for stabilizing the towed wheeled vehicle. Current related art stabilizers are bulky and cumbersome when stored and not in use, taking up a large amount of storage space. Few existing stabilizers can be disassembled to a smaller size for storage when not in use. Existing art does allow for some height adjustment of the support apparatus, but adjustments are considered minimal. Most designs do not address elevation differences where the support legs contact the ground.

U.S. Pat. No. 4,708,362 (Raetz) discloses an apparatus that contacts the towing coupler of a towed wheeled vehicle. The apparatus uses two pivoting support legs connected together with a tensioning device that when tightened draw the support legs together creating an upward force on the towing coupler. The support legs appear to be a fixed length, with a pivoting foot at the bottom of the support leg to allow for elevation difference between the support legs.

U.S. Pat No. US 2009/0200782 A1 (Albrecht et al.) discloses an apparatus that uses permanently attached fixtures that attach to the housing of the towing coupler to mount a pair of pivoting adjustable length support legs connected together with a tensioning device that when tightened draw the support legs together creating an upward force on the frame of the towed wheeled vehicle. The support legs are adjustable in length, and have a pivoting foot at the bottom of the support leg. This apparatus appears to function best by utilizing the leveling system of the towed wheeled vehicle. By lowering the front end of the leveling system, force is applied to the tensioning device between the support legs, creating a rigid body to stabilize the towed wheeled vehicle.

U.S. Pat. No. 6,062,524 (Jackson, Sr.) discloses an apparatus that attaches to the towing coupler of a towed wheeled vehicle. The design consists of a mounting device that attaches to the towing coupler, a long threaded bar, two support legs that are held together by braces that attach to each support leg, and pivoting feet. The braces keep the support legs together as a force is applied to the apparatus. The braces have a various number of holes for to allow for adjustment of the distance between the support legs. The braces are bolted together to keep them from separating. The apparatus utilizes a long threaded bar for height adjustments of the stabilizer.

U.S. Pat. No. 4,905,953 (Wilson), 2002/0027354 A1 (Holly), U.S. Pat. No. 5,575,492 (Stone), U.S. Pat. No. 6,331,016 B1 (Wallace et al.), U.S. Pat. No. 6,095,474 (Arnold), U.S. Pat. No. 3,933,372 (Herndon) also disclose stabilization devices intended for use on a stationary free standing towed wheeled vehicle.

### BRIEF SUMMARY OF THE INVENTION

The present invention is directed to a collapsible adjustable height stabilizing apparatus for a towed wheeled vehicle containing a towing coupler such as a king pin, or towing ball that eliminates unwanted motion of the stationary free standing towed wheeled vehicle caused by external forces such as wind or human activity inside the towed wheeled vehicle.

Another objective of the invention is to create a compact, easy to use and easy to store apparatus when the apparatus is not in use.

Another objective of this invention is to create a stabilizer that can be utilized on the towed wheeled vehicle without having to adjust the leveling system of the towed wheeled vehicle to install, remove or properly use.

Another objective of this invention is to create a stabilizer that can be fully functional where elevation difference between the support legs is required.

### BRIEF DESCRIPTION OF THE DRAWINGS

FIG. 1 shows the apparatus in its completely collapsed condition.

FIG. 2 illustrates the apparatus in a typical extended condition.

FIG. 3 represents a side view of the apparatus showing the extension of the support legs.

FIG. 4 shows an angled view of the adjustable settings of the support legs.

FIG. 5 depicts the apparatus pivoting and extending.

FIG. 6 shows an angled front view of the mounting plate used for attaching the apparatus to the towing coupler of a towed wheeled vehicle. The illustration shows the mounting plate without any other ancillary components.

FIG. 7 shows a bottom view the mounting plate used for attaching the apparatus to the towing coupler of a towed wheeled vehicle. The illustration shows the mounting plate without the support legs attached.

FIG. 8 shows an angled back view of the mounting plate used for attaching the apparatus to the towing coupler of a towed wheeled vehicle. The illustration shows the mounting plate without any other ancillary components.

FIG. 9 shows a detailed side view of the mounting plate attached to a king pin towing coupler.

FIG. 10 shows a side view of a version of a mounting plate used for attaching the apparatus to the towing coupler of a towed wheeled vehicle.

FIG. 11 shows a side view of another version of a mounting plate used for attaching the apparatus to the towing coupler of a towed wheeled vehicle.

FIG. 12 illustrates the apparatus in a completely collapsed condition attached to the towing coupler of a towed wheeled vehicle.

FIG. 13 shows the apparatus attached to the towing coupler of a towed wheeled vehicle in an extended condition with an elevation difference of the ground.

FIG. 14 illustrates the apparatus attached to the towing coupler of a towed wheeled vehicle in an extended condition on level ground.

FIG. 15 shows a side view of a towed wheeled vehicle with the apparatus attached to the towed wheeled vehicle's towing coupler. The support legs are extended to be in contact with the ground.

### DETAILED DESCRIPTION OF THE PREFERRED EMBODIMENT

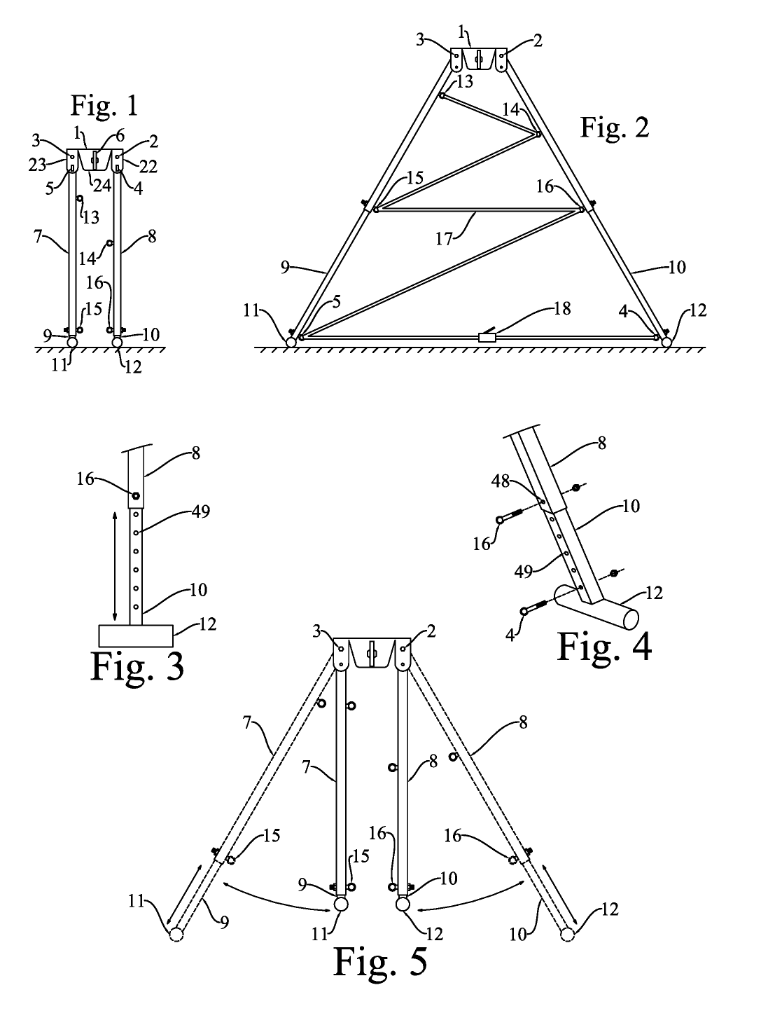

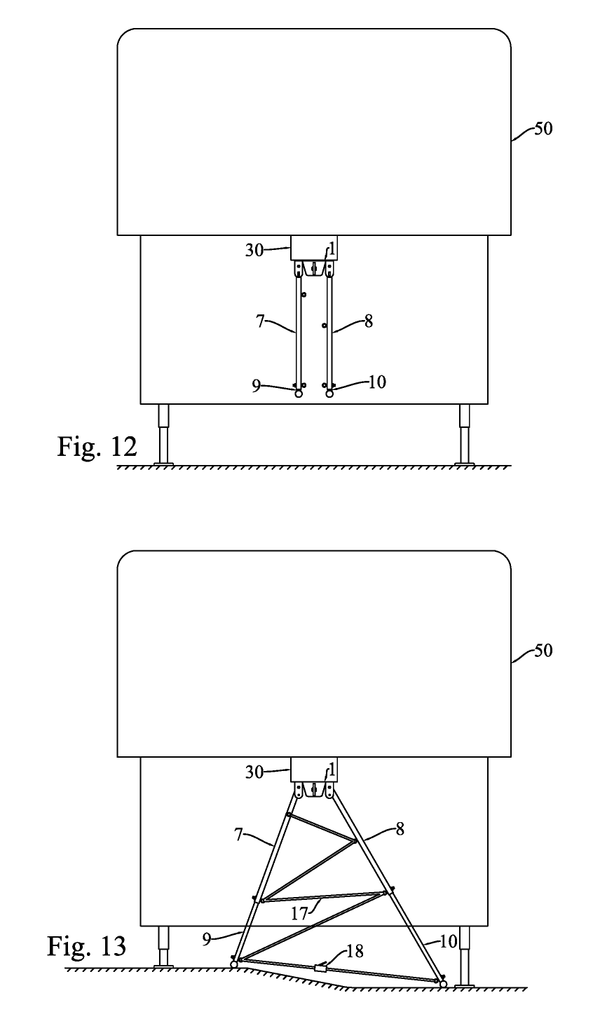

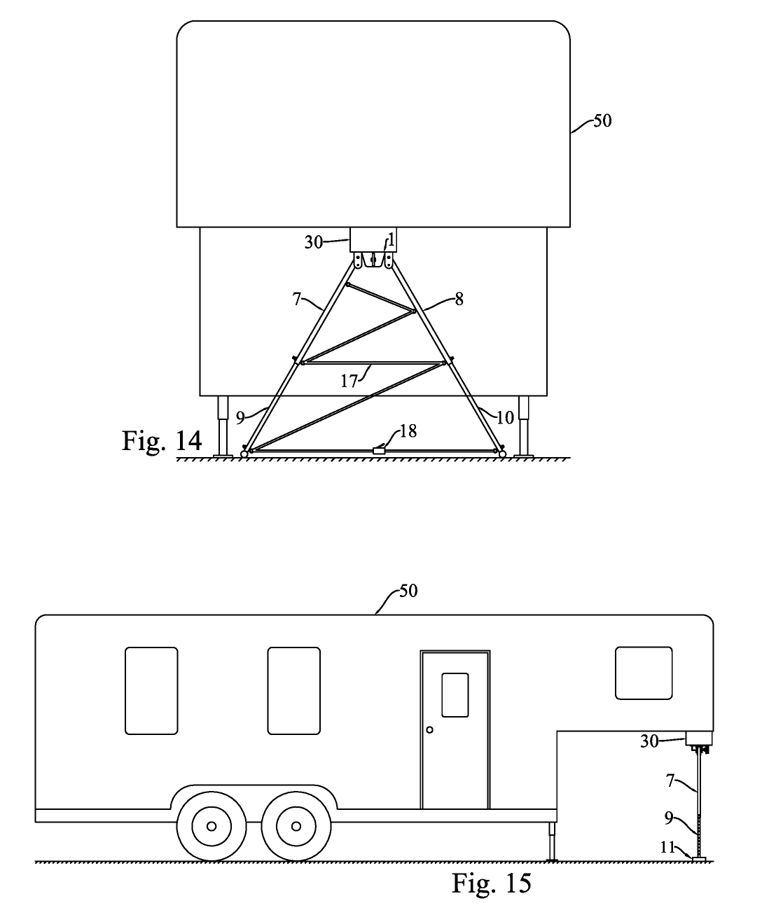

The preferred embodiment of the invention is shown in its fully collapsed condition in FIG. 1 and FIG. 12, and in a typical extended condition in FIG. 2, FIG. 13, FIG. 14, and FIG. 15. The preferred embodiment consists of a mounting plate, adjustable length pivoting support legs, feet to contact the ground, and a tensioning device. The material that the preferred embodiment's mounting plate, adjustable length pivoting support legs and feet is preferable made of is steel, but could possibly be a vast array of different materials, including but not limited to wood, plastic, aluminum, or cast iron.

As the preferred embodiment is a separate apparatus from a towed wheeled vehicle 50, it requires being attached to a towed wheeled vehicle 50 to be fully functional. The preferred embodiment also requires a transformation from its completely collapsed condition as seen in FIG. 1 and FIG. 12, to its extended condition as seen in FIG. 2, FIG. 13, FIG. 14 and FIG. 15. Due to the transformation requirements, it is necessary for the preferred embodiment to be able to securely attach to the towing coupler and hang without the aid of the support legs 7, 8, 9, and 10 contacting the ground. This hanging support system allows the user the ability to transform the preferred embodiment without having to hold the weight of the apparatus during the transformation process. This hanging support is accomplished by utilizing the towing coupler of the towed wheeled vehicle 50 and the features incorporated into the design of the mounting plate.

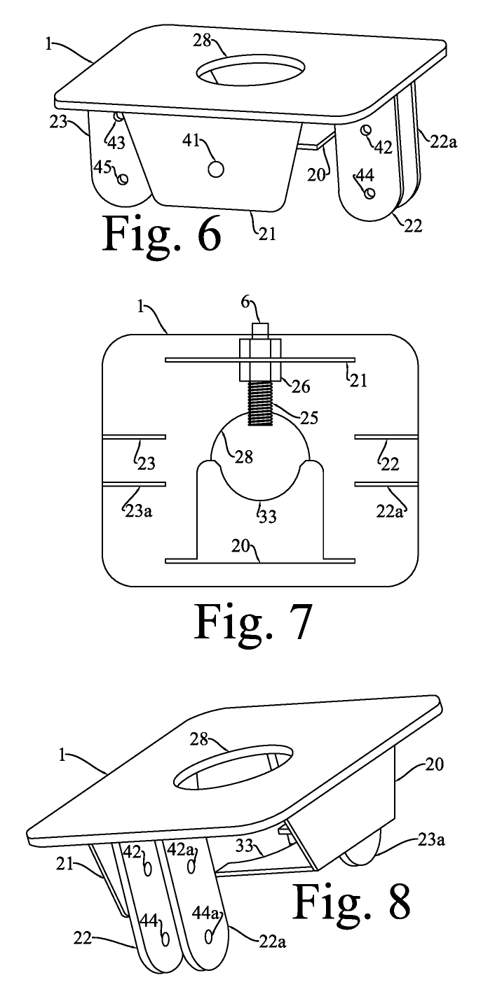

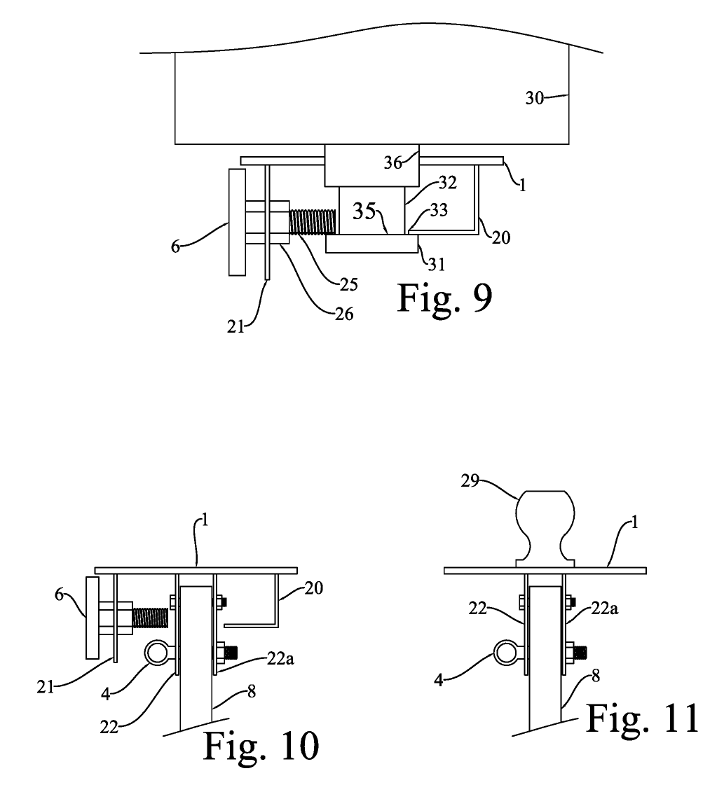

The detailed views of the mounting plate of the preferred embodiment are shown in FIG. 6, FIG. 7, FIG. 8, FIG. 9, FIG. 10 and FIG. 11.

The preferred embodiment requires support legs 7, 8, 9, and 10 and feet 11 and 12. Support legs 7, 8, 9, and 10 extend from the mounting plate to the feet 11 and 12, which contact the ground. Outer support legs 7 and 8 have permanently attached tensioning anchors 13 and 14 placed along one edge, at a non-equal distance from the mounting plate. Views of the support legs 7, 8, 9, and 10 with feet 11 and 12 of the preferred embodiment are shown in FIG. 1, FIG. 2, FIG. 3, FIG. 4, FIG. 5, FIG. 12, FIG. 13, FIG. 14, and FIG. 15. Tensioning anchors 13 and 14 are shown in FIG. 1, FIG. 2, FIG. 5, FIG. 12, FIG. 13, FIG. 14, and FIG. 15.

The preferred embodiment also requires support legs 7, 8, 9, and 10 have a forced placed on them that draws the support legs towards each other. The preferred embodiment utilizes a tensioner to create this required force. The tensioner is shown in FIG. 2, FIG. 13, and FIG. 14. Tensioning anchors 13 and 14, and tensioning bolts 15, 16, 5 and 4 create anchor points for the tensioner. Tensioning bolts 15, 16, 5 and 4 are steel bolts with an eyelet on one end and threads on the other end. All tensioning bolts are alike, and utilize a threaded nut to hold the bolt in place. A detailed view of tensioning bolts 16 and 4 can be seen in FIG. 4.

For the preferred embodiment, the tensioner is made up of tensioning media 17 and tensioning device 18. Tensioning media 17 can be but is not limited to a flat nylon strap, a cable, a rope, a chain, or a wire. Tensioning device 18 can be but is not limited to a ratcheting-type tensioner or a cam-action tensioner.

Shown in FIG. 6, FIG. 7, FIG. 8, FIG. 9 and FIG. 10 is one version of the mounting plate that consists of a top plate 1, support leg mounts 22, 22a, 23 and 23a, an L shaped bracket 20, and a bolt bracket 21, a Tee handle bolt 6 with threads 25, and an attached threaded nut for the Tee handle bolt 26. The top plate 1 has a circular hole 28 to accommodate the towing coupler, such as a king pin 31. Circular hole 28 has a diameter slightly larger than the towing couplers maximum diameter 36. The bolt bracket 21 has a thru hole 41 to accommodate the Tee handle bolt 26. On the side of bolt bracket 21 facing L shaped bracket 20, a threaded nut for the Tee handle bolt 26 is placed aligned with the thru hole 41. The nut can either be permanently attach by means of welding or gluing, or can be temporarily attached by threading on the Tee handle bolt 21. Assuming that nut 26 is permanently attached to bolt bracket 21, Tee handle bolt 6 is inserted into the thru hole of the bolt bracket 21 and threaded into the nut 26. The Tee handle bolt 6 uses its threads 25 and the threads of the nut 26 to create an adjustable length support feature. As shown in FIG. 9 when the Tee handle bolt 6 is screwed in to its maximum allowable depth, the end of the bolt rests on the lower shelf edge 35 of the towing coupler, such as a king pin 31. Thus creating a supporting feature for the mounting plate. As can be seen in FIG. 7, the L shaped bracket 20 opposite of bolt bracket 21 has a semi-circle shape 33 in the bottom section of the L shaped bracket 20. The diameter of the semi-circle 33 being similar in size to the towing coupler minimum diameter 32 to ensure minimal clearance between components. As shown in FIG. 7, the semi-circle shape 33 in the bottom section of the L shape bracket 20 rests on the lower shelf edge 35 of the towing coupler, such as a king pin 31. Thus creating another supporting feature for the mounting plate. The two supporting features being on opposite sides of each other of the towing coupler 31, support the preferred embodiment and keep it suspended on the towed wheeled vehicle's towing coupler until the support legs 7, 8, 9, and 10 are deployed for use. An example of a suspended preferred embodiment is shown in FIG. 12.

Another version of the mounting plate can be seen in FIG. 11, and incorporates a towing ball 29 attached to the top side of the top plate 1. The towing ball 29 is permanently attached to the top plate 1. The methods of attachment of towing ball 29 to top plate 1 can be but are not limited to threading, welding or gluing.

To attach the preferred embodiment onto the towed wheeled vehicle towing ball 29 is inserted into the towing coupler of the towed wheeled vehicle. Once the towing coupler is engaged with the towing ball 29, the preferred embodiment would be suspended from the towed wheeled vehicle until the support legs 7, 8, 9, and 10 are deployed for use. An example of a suspended preferred embodiment is shown in FIG. 12.

Support leg mounts 22, 22a, 23 and 23a are permanently attached to the underside of top plate 1 and are utilized to attach the outer support legs 7, and 8 to the mounting plate. The methods of attachment of support leg mounts 22, 22a, 23 and 23a to top plate 1 can be but are not limited to welding or gluing. As seen in FIG. 7 support leg mounts 22 and 22a are located on one side of top plate 1, and, support leg mounts 23 and 23a are located on the opposite side of top plate 1. Support leg mounts 22 and 22a are located directly in line with each other, as seen in FIG. 7 and FIG. 10 at a distance apart enough for outer support leg 8 to fit between them with minimal clearance. Support leg mounts 23 and 23a are also located directly in line with each other, as seen in FIG. 7 at a distance apart enough for outer support leg 7 to fit between them with minimal clearance. As seen in FIG. 6 and FIG. 8, each support leg mount has two thru holes used for attaching the outer support legs 7 and 8 to the support leg mounts. Support legs 7 and 8 have matching thru holes.

Outer support leg 8 is placed between support leg mounts 22 and 22a. Pivot bolt 2 is inserted into thru hole 42 of support leg mount 22, thru outer support leg 8 and thru thru hole 42a of support leg mount 22a. All Pivot bolts can be but are not limited to a threaded bolt using a threaded nut for assembly, a large rivet, or a pin with a securing device. Pivot bolt 2 is secured in place.

Outer support leg 7 is placed between support leg mounts 23 and 23a. Pivot bolt 3 is inserted into thru hole 43 of support leg mount 23, thru outer support leg 7 and thru thru hole 43a of support leg mount 23a. Pivot bolt 3 is secured in place.

Support legs 7, 8, 9, and 10 of the preferred embodiment work together to create support for the mounting plate that is attached the towing coupler of the towed wheeled vehicle 50. Support legs 7, 8, 9, and 10 of the preferred embodiment are preferable a thin walled cross sectional square shape, but could possibly be a thin walled cross sectional round shape, or a thin walled cross sectional rectangle shape. Outer support legs 7 and 8 have an inner diameter large enough for inner support legs 9 and 10 to fit inside with minimal clearance. As seen in FIG. 4 outer support leg 8 has a thru hole 48 at its lower end. Outer support leg 7 has the same thru hole. Inner support leg 10 slides telescopically in and out of outer support leg 8. As can be seen in FIG. 3, and FIG. 4 inner support leg 10 has a series of thru holes 49 placed over the entire length of the support leg. Each thru hole being equidistance apart, allowing for multiple adjustments in total support leg length of outer support leg 8 and inner support leg 10. At the very bottom of inner support leg 10, foot 12 is permanently attached. Inner support leg 10 is attached to the outer diameter surface of foot 12. Inner support leg 9 slides telescopically in and out of outer support leg 7. Inner support leg 9 has a series of thru holes 49 placed over the entire length of the support leg. Each thru hole being equidistance apart, allowing for multiple adjustments in total support leg length of outer support leg 7 and inner support leg 9. At the very bottom of inner support leg 9, foot 11 is permanently attached. Inner support leg 9 is attached to the outer diameter surface of foot 11.

Feet 11 and 12 of the preferred embodiment are preferable a thick walled cross sectional round shape, but could possibly be a thin rectangular plate mounted to the bottom of inner support legs 9 and 10 with a pivoting feature to allow the plate to contact the ground over a larger surface area.

For the preferred embodiment, the entire support system is considered to contain support legs 7, 8, 9, 10, and feet 11 and 12. Tensioning bolts 15 and 16 are also considered part of the entire support system and utilized to keep inner support legs 9 and 10 connected to outer support legs 7 and 8.

The preferred embodiment is considered assembled when the entire support system is connected to the mounting plate utilizing pivot bolts 2 and 3. Without the use of tensioning bolts 4 and 5, support legs 7, 8, 9, and 10 are able to pivot side to side about pivot bolt 2 and 3. This state for the preferred embodiment is considered its pivoting condition. FIG. 5 shows the pivoting movement of the entire support system with respect to the mounting plate.

Pivoting movement of support legs 7 and 9 is stopped by inserting tensioning bolt 5 into thru hole 45 of support leg mount 23, thru outer support leg 7 and thru thru hole 45a of support leg mount 23a. A nut is threaded onto the threaded end of the tensioning bolt to keep the tensioning bolt 5 in place. Pivoting movement of support legs 8 and 10 is stopped by inserting tensioning bolt 4 into thru hole 44 of support leg mount 22, thru outer support leg 8 and thru thru hole 44a of support leg mount 22a. A nut is threaded onto the threaded end of the tensioning bolt to keep the tensioning bolt 4 in place. With tensioning bolts 4 and 5 holding the support legs in place, the entire preferred embodiment becomes rigid and easily mobile for such activities as carrying, storing, attaching to towing coupler of towed wheeled vehicle, or removing from towing coupler of towed wheeled vehicle. The rigid state is also considered its non-pivoting condition.

The telescopic movement of inner support legs 9 and 10 is controlled by tensioning bolts 15 and 16. When the preferred embodiment is in its fully collapsed condition, the inner support legs are slid all the way in to the outer support legs. Utilizing thru hole 48 of outer support legs 7 and 8, and the thru hole 49 of inner support legs 9 and 10, tensioning bolts 4 and 5 are inserted into thru hole 49 of inner support legs 9 and 10 that is closet to feet 11 and 12, and secured with a nut threaded onto its threaded end of the bolts.

The preferred embodiment is normally considered to be in its non-functional, non-working state when it is in its fully collapsed, non-pivoting condition as seen in FIG. 1 and FIG. 12. The fully collapsed condition is considered ideal for storage when not in use and for ease of mobility of the preferred embodiment.

The actual use of the preferred embodiment is considered to begin with the apparatus in its fully collapsed, non-pivoting condition. It is also a requirement that the towed wheeled vehicle be disconnected from its towing vehicle and be in a free standing state with its towing coupler accessible.

The attachment process of the preferred embodiment to the towed wheeled vehicle containing the mounting plate version shown in FIG. 6, FIG. 7, FIG. 8, FIG. 9 and FIG. 10 is as follows. The type of towing coupler required for this mounting plate would be a king pin. Beginning with the preferred embodiment in its fully collapsed, non-pivoting condition in an orientation so that the top plate 1 of the mounting plate is facing the underside of the towing coupler frame 30 and the support legs 7, 8, 9, and 10 are directed downward towards the ground. Feet 11 and 12 should be in contact with ground to minimize the amount of time that the user is required to hold the weight of the apparatus during instillation. It is necessary for Tee handle bolt 6 to be unscrewed from nut 26 approximately half of its entire length. Tee handle 6 and bolt bracket 21 should be facing the user during the attachment process. The entire apparatus is aligned under the towing coupler frame 30 so that circular hole 28 of top plate 1 is aligned with the king pin towing coupler with feet 11 and 12 in contact with the ground. The apparatus is then lifted upward, off of the ground, inserting the king pin towing coupler thru circular hole 28, continuing upward movement until top plate 1 comes in contact with the underside of the towing coupler frame 30. The entire apparatus is then simultaneous slightly lowered and pulled toward the user until semi-circle shape 33 in the bottom section of the L shape bracket 20 rests on the lower shelf edge 35 of the king pin towing coupler as shown in FIG. 9. At this point the weight of the apparatus is supported by the towed wheeled vehicle's towing coupler. Tee handle 6 is now screwed all the way in, creating another weight bearing feature for the apparatus as seen in FIG. 9.

With the preferred embodiment secured to the towing coupler of the towed wheeled vehicle, tensioning bolts 4 and 5 are removed from the assembly, allowing support legs 7, 8, 9, and 10 the freedom to pivot about pivot bolts 2 and 3.

Tensioning bolts 15 and 16 are removed from the assembly, allowing inner support legs 9 and 10 the freedom to telescopically move downward from outer support legs 7 and 8. Inner support legs 9 and 10 are lowered until feet 11 and 12 contact the ground. The desired angle of the support leg assembly is adjusted by pivoting the support legs and allowing the inner support leg to move telescopic downward from the outer support leg allowing the feet to be in contact with the ground. The pivoting and telescopic movement of the support legs is shown in FIG. 4. The user selects the desired angle for each support leg assembly independently. Once the desired angle of each support leg has been select, the telescopic motion must be secured for each of the support leg assemblies. The order of securing the support leg assembles makes no difference to the functionality of the apparatus, and for this example support legs 8 and 10 will be secured first. As seen in FIG. 4 the thru hole 48 of outer support leg 8 and one of the thru holes 49 of inner support leg 10 are aligned, and tensioning bolt 16 is inserted with its eyelet facing the opposite support legs, thru both support legs 8 and 10. A nut is threaded onto the threaded end of tensioning bolt 14 to keep tensioning bolt 14 in place. FIG. 3 and FIG. 4 are views representing the placement and orientation of tensioning bolt 16 and support legs 8 and 10 secured. Tensioning bolt 4 is then inserted with its eyelet facing the opposite support legs, into thru hole 49 of inner support leg 10 that is closet to foot 12, and secured with a nut threaded onto its threaded end as seen in FIG. 4.

The same process is repeated for securing inner support leg 9 and outer support leg 7 utilizing tensioning bolts 15 and 5 and the thru holes of each support leg. The orientation of the tensioning bolts is with the eyelets facing the opposite support leg assembly as shown in FIG. 1, FIG. 2, FIG. 4, FIG. 5, FIG. 12, FIG. 13 and FIG. 14.

With the mounting plate secured to the towing coupler of the towed wheeled vehicle, the support legs set and secured at the desired angles, the tensioner is ready to be attached. The tensioner is shown in FIG. 2, FIG. 13, and FIG. 14. For the preferred embodiment tensioning media 17 is a flat nylon strap having a metal hook attached at one end. Also for the preferred embodiment, tensioning device 18 is a ratcheting-type tensioner located on one end of a short length of flat nylon strap, with a metal hook located on the other end. The metal hook of tensioning media 17 is first attached to tensioning anchor 13. There can be multiple ways of routing tensioning media 17 thru tensioning anchor 14 and eyelets of tensioning bolts 15, 16, 5 and 4. The preferred route is shown in FIG. 2, FIG. 13, and FIG. 14 and is as follows. The loose end of tensioning media 17 is inserted and passed thru tensioning anchor 14, then routed to and passed thru the eyelet of tensioning bolt 15, then routed to and passed thru the eyelet of tensioning bolt 16, then routed to and passed thru the eyelet of tensioning bolt 5. The tail end of tensioning media 17 is then inserted into the ratcheting feature of tensioning device 18. The metal hook of tensioning device 18 is secured to the eyelet of tensioning bolt 4 to complete the route of the tensioner. The ratcheting feature of tensioning device 18 is utilized to create tension on the entire tensioner assembly, drawing the support legs towards each other. A good amount of tension is required for the preferred embodiment to functional properly.

The tension that is present between the support legs make the preferred embodiment act as a rigid body, and creates an upward force that is acting on the towing coupler frame 30. The force helps stabilize the frame and suspension system of the towed wheeled vehicle, eliminating unwanted movement of the stationary free standing towed wheeled vehicle.

The removal of the apparatus is accomplished by reversing the order of installation until the preferred embodiment has returned to its fully collapsed non-pivoting condition.

To utilize another version of the apparatus containing the version of the mounting plate shown in FIG. 11, the attachment process to the towed wheeled vehicle's towing coupler is the only process that changes. The pivoting, telescoping and tensioning processes are identical as to the above process for the other type of mounting plate. The attachment process for the mounting plate shown in FIG. 11 is as follows. As seen in FIG. 11, this version of the mounting plate incorporates a towing ball 29 that is attached to the top side of the top plate 1. Towing ball 29 is inserted into the towing coupler of the towed wheeled vehicle. The towing coupler is activated securing towing ball 29 into the towed wheeled vehicle's towing coupler. Once the towing coupler is engaged with the towing ball 29, the weight of the preferred embodiment is supported by the towed wheeled vehicle's towing coupler. An example of a suspended preferred embodiment is shown in FIG. 12. The preferred embodiment is now ready to proceed with the pivoting, telescoping and tensioning processes.

The removal of the version of the apparatus containing towing ball 29 is accomplished by reversing the order of installation until the preferred embodiment has returned to its fully collapsed non-pivoting condition. The last step of removal required deactivating the towed wheeled vehicle's towing coupler to release towing ball 29 from the towing coupler.

What is claimed is:

1. A collapsible adjustable mechanism for stabilizing a stationary free standing towed wheeled vehicle existing in two configurations, collapsed and operational, having a king pin towing coupler comprising:
a. a mounting plate that affixes to the king pin towing coupler
b. a pair of pivoting collapsible adjustable height support legs, each support leg compromising of an outer leg and inner leg, with the outer leg being attached at its upper end to the mounting plate, and the inner leg having a foot at is lower end.
c. a tensioning device attached between the support legs.

2. The mechanism according to claim 1, when affixed to the king pin towing coupler supports its own weight without the aid if the support legs contacting the ground.

3. The mechanism according to claim 1, where the tensioning device is routed through multiple anchor points along each support leg.

4. The mechanism according to claim 1, where the tensioning device includes a ratcheting type tensioner.

5. The mechanism according to claim 1, where the support legs are adjustable in length.

6. The mechanism according to claim 5, where each support leg compromises a pair of telescopic leg sections.

7. A collapsible adjustable mechanism for stabilizing a stationary free standing towed wheeled vehicle existing in two configurations, collapsed and operational, having a towing coupler that connects to a towing ball comprising:
a. a mounting plate with a towing ball that affixes to the towing coupler
b. a pair of pivoting collapsible adjustable height support legs, each support leg compromising of an outer leg and inner leg, with the outer leg being attached at its upper end to the mounting plate, and the inner leg having a foot at is lower end.
c. a tensioning device attached between the support legs.

8. The mechanism according to claim 7, when affixed to the towing coupler supports its own weight without the aid if the support legs contacting the ground.

9. The mechanism according to claim 7, where the tensioning device is routed through multiple anchor points along each support leg.

10. The mechanism according to claim 7, where the tensioning device includes a ratcheting type tensioner.

11. The mechanism according to claim 7, where the support legs are adjustable in length.

12. The mechanism according to claim 11, where each support leg compromises a pair of telescopic leg sections.
